(19) United States
(12) Patent Application Publication
(10) Pub. No.: US 2023/0303140 A1
(43) Pub. Date: Sep. 28, 2023

(54) EXTENDABLE HAND TRUCK

(71) Applicant: Tom Kite, Indianapolis, IN (US)

(72) Inventor: Tom Kite, Indianapolis, IN (US)

(21) Appl. No.: 18/100,657

(22) Filed: Jan. 24, 2023

Related U.S. Application Data
(60) Provisional application No. 63/324,291, filed on Mar. 28, 2022.

(51) Int. Cl. B62B 1/12; B62B 1/00

(52) U.S. Cl. CPC B62B 1/125; B62B 1/002; B62B 2206/02

(57) ABSTRACT

A hand truck includes a chassis, a nose plate disposed at a lower end of the chassis, a handle disposed at an upper end of the chassis, a plurality of wheels and a fastener. The chassis includes a first section and a second section. The fastener locks the first section relative to the second section in a first arrangement and permits movement of the first section relative to the second section in a second arrangement.

### RELATED APPLICATIONS

The present application claims priority to U.S. Provisional Patent Application Ser. No. 63/324,291, filed Mar. 28, 2022, the entire disclosure of which is expressly incorporated by reference herein.

### FIELD OF THE DISCLOSURE

The present disclosure relates generally to hand trucks, and more particularly, to hand trucks with extendable chassis.

### BACKGROUND OF THE DISCLOSURE

Conventional hand trucks allow operators to transport items without having to manually lift the full weight of the items. However, when transporting oversized items, the operator must continuously balance the items so as to prevent the items from falling. Accordingly, there is a need for improved hand truck designs that can accommodate different sized items.

### BRIEF SUMMARY OF THE DISCLOSURE

In an exemplary embodiment of the present disclosure, a hand truck is provided. The hand truck includes a chassis, a nose plate, a handle, a plurality of wheels and a fastener. The chassis includes a first section and a second section with the first section being moveable relative to the second section. The first section and the second section cooperate to form a cargo support surface. The nose plate is disposed at a lower end of the chassis while the handle is disposed at an upper end of the chassis. The plurality of wheels includes a first wheel and a second wheel disposed adjacent the nose plate and a third wheel disposed adjacent the handle. In a first arrangement, the fastener operates to lock the first section relative to the second section. In a second arrangement, the fastener operates to permit movement of the first section relative to the second section. The fastener is carried by one of the first section and the second section in both the first arrangement and the second arrangement.

In one example, the first section includes an extension member mounted in a telescoping relationship with the second section to allow an operator to adjust a distance between the nose plate and the handle. In a refinement thereof, the first section includes a first and second extension members mounted in telescoping relationships with the second section. The first and second extension members extend relative to the second section to provide a first area of the cargo support surface and retract relative to the second section to provide a second area of the cargo support surface that is smaller than the first area.

In another example, the fastener includes an operator input, a retractable pin and a biasing member. In the first arrangement, the retractable pin is received in an opening in the extension member. In the second arrangement, the retractable pin is removed from the opening in the extension member. Absent an actuation of the operator input, the biasing member operates to bias the retractable pin into the opening in the extension member. In yet another example, the fastener includes a hooking element coupled to the operator input and the retractable pin. The hooking element moves in response to the actuation of the operator input. In turn, the hooking element moves the retractable pin such that the retractable pin is either received in the opening in the extension member or removed from the opening in the extension member.

In a variation thereof, the fastener includes a pair of retractable pins and a pair of biasing members. In the first arrangement, a first retractable pin of the pair of retractable pins is received in an opening in the first extension member and a second retractable pin of the pair of retractable pins is received in an opening in the second extension member. In the second arrangement, the first retractable pin is removed from the opening in the first extension member and the second retractable pin is removed from the opening in the second extension member. Absent an actuation of the operator input, the pair of biasing members operates to bias the pair retractable pins into the respective openings in the first and second extension members.

In a further example, the operator input is positioned between the first and second extension members. The operator input is positioned on a first side of the chassis opposite the cargo support surface and along a longitudinal centerline plane of the hand truck. The operator input may be a rotatable knob. In a yet further example, each of the plurality of wheels extends away from the first side of the chassis opposite the cargo support surface. Each of the plurality of wheels is coupled to the second section independent of the first section of the chassis.

In still another example, the hand truck is configured to move between a first orientation and a second orientation. In the first orientation, the first wheel and the second wheel are in contact with a surface to roll over the surface while the third wheel is not in contact with the surface. In the second orientation, the first wheel, the second wheel and the third wheel are in contact with the surface to roll over the surface. When configured in the first orientation, the handle is in a folded position aligned parallel to the chassis. When configured in the second orientation, the handle is in an upright position aligned perpendicular to the chassis.

### BRIEF DESCRIPTION OF THE DRAWINGS

The above-mentioned and other features and advantages of this disclosure, and the manner of attaining them, will become more apparent and will be better understood by reference to the following description of exemplary embodiments taken in conjunction with the accompanying drawings, wherein:

FIG. 1 illustrates a perspective view of an extendable hand truck;

FIG. 2 illustrates a side view of the extendable hand truck of FIG. 1;

FIG. 3 illustrates a front view of the extendable hand truck of FIG. 1;

FIG. 4 illustrates a back view of the extendable hand truck of FIG. 1;

FIG. 5 illustrates a top view of the extendable hand truck of FIG. 1;

FIG. 6 illustrates a bottom view of the extendable hand truck of FIG. 1;

FIG. 7 illustrates an exploded view of the extendable hand truck of FIG. 1;

FIG. 8 illustrates a sectional view of the extendable hand truck of FIG. 1;

FIGS. 9 and 10 illustrate perspective views of a frontend of the extendable hand truck;

FIGS. 11-13 illustrate sectional views of the frontend of the extendable hand truck of FIG. 9; and

FIGS. 14-16 illustrate close-up sectional views of the frontend of the extendable hand truck of FIG. 9.

Corresponding reference characters indicate corresponding parts throughout the several views. The exemplification set out herein illustrates an exemplary embodiment of the invention and such exemplification is not to be construed as limiting the scope of the invention in any manner.

### DETAILED DESCRIPTION OF THE DRAWINGS

For the purposes of promoting an understanding of the principles of the present disclosure, reference is now made to the embodiments illustrated in the drawings, which are described below. The embodiments disclosed herein are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples,” “coupled,” “coupler” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

In some instances throughout this disclosure and in the claims, numeric terminology, such as first, second, third, and fourth, is used in reference to various components or features. Such use is not intended to denote an ordering of the components or features. Rather, numeric terminology is used to assist the reader in identifying the component or features being referenced and should not be narrowly interpreted as providing a specific order of components or features.

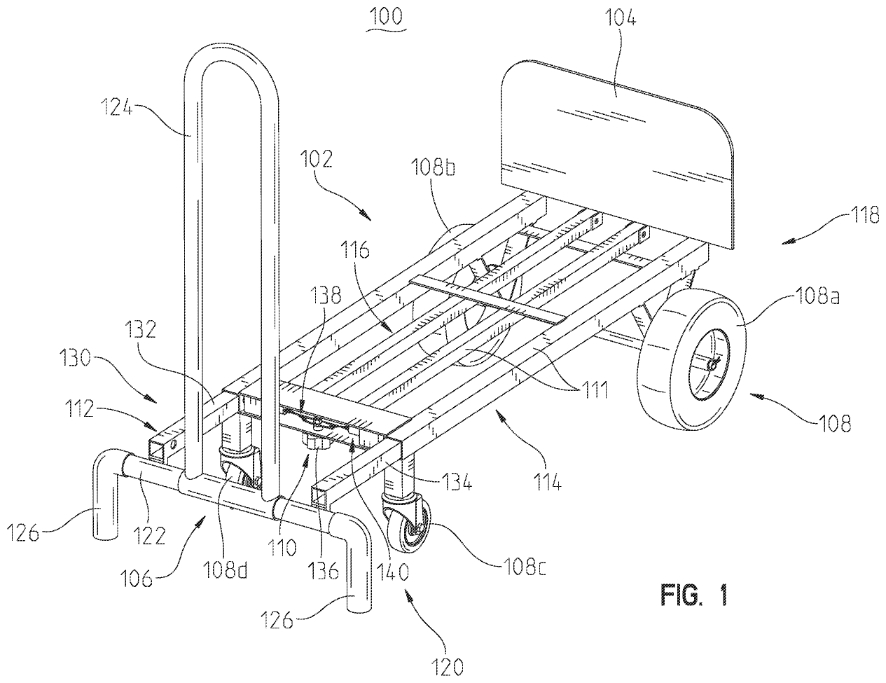

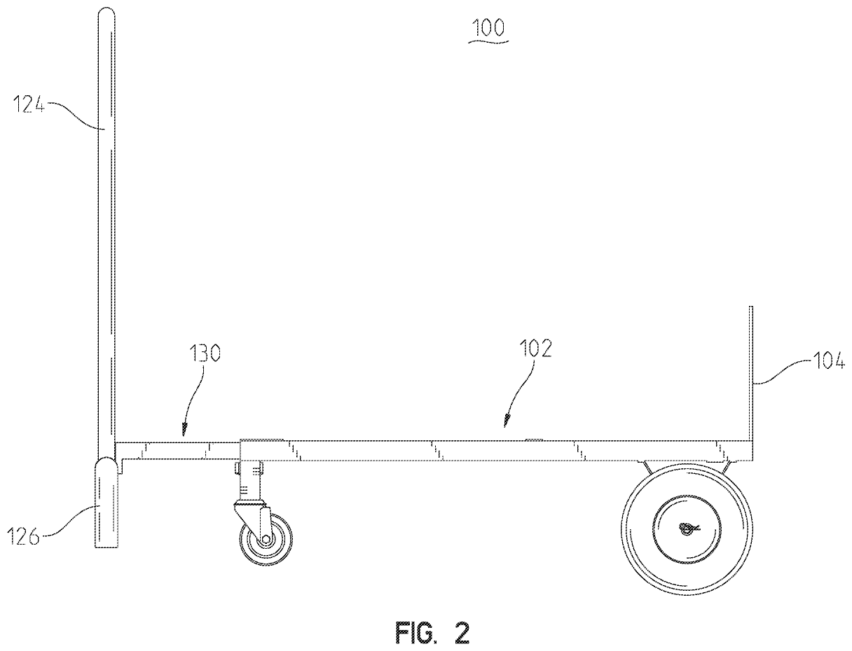

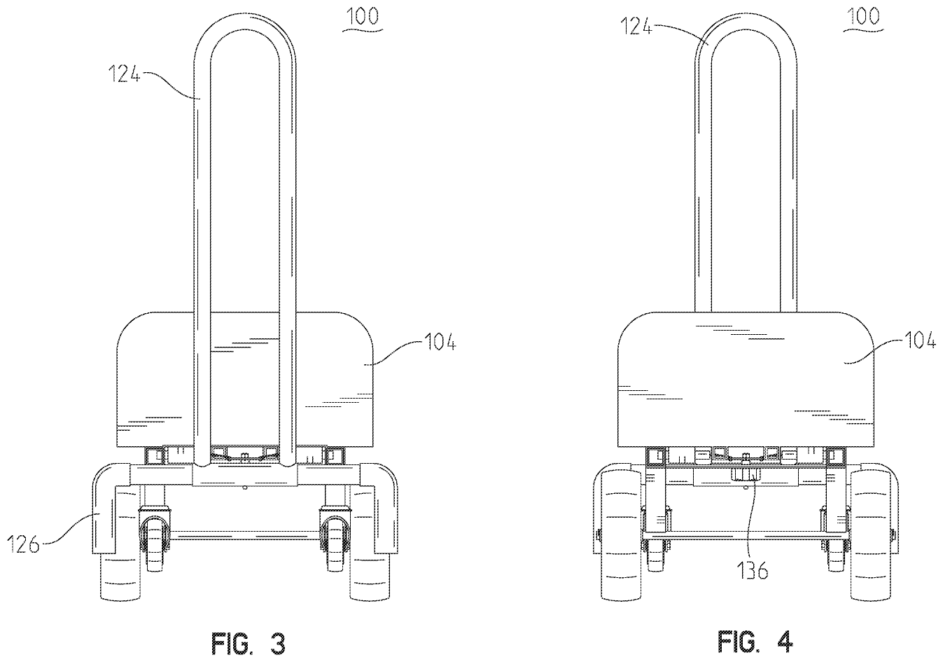

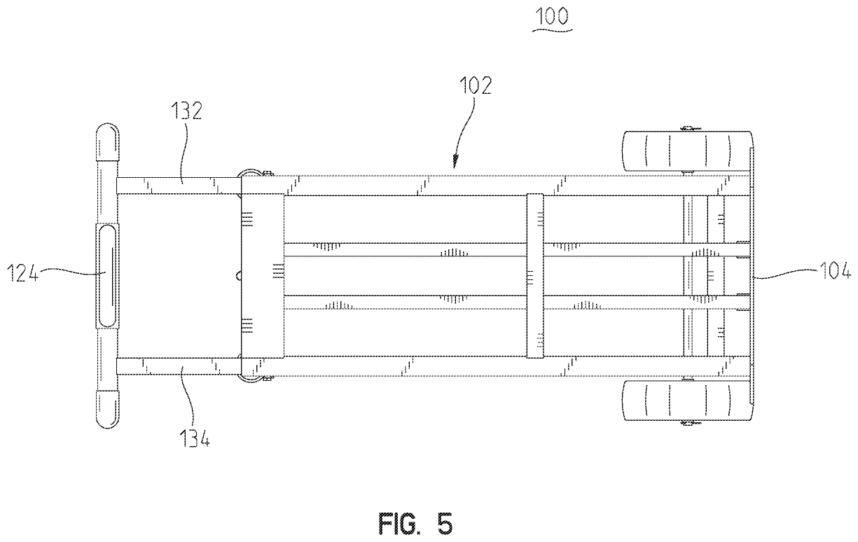

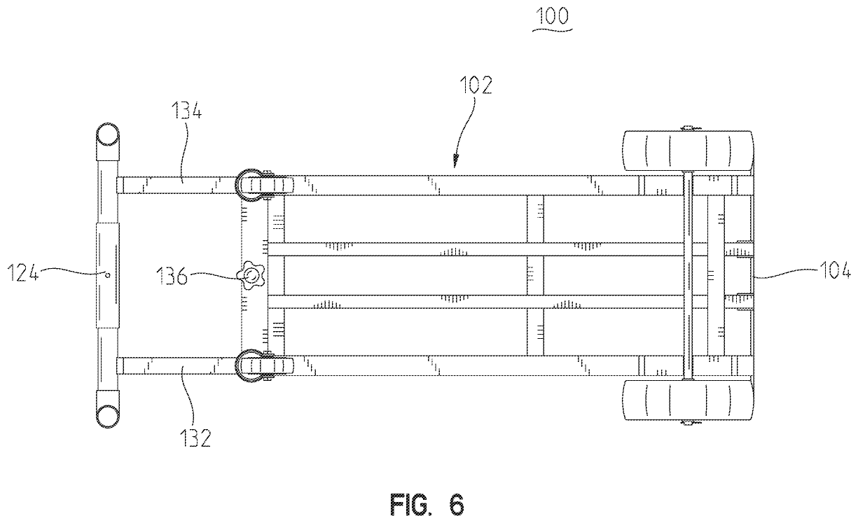

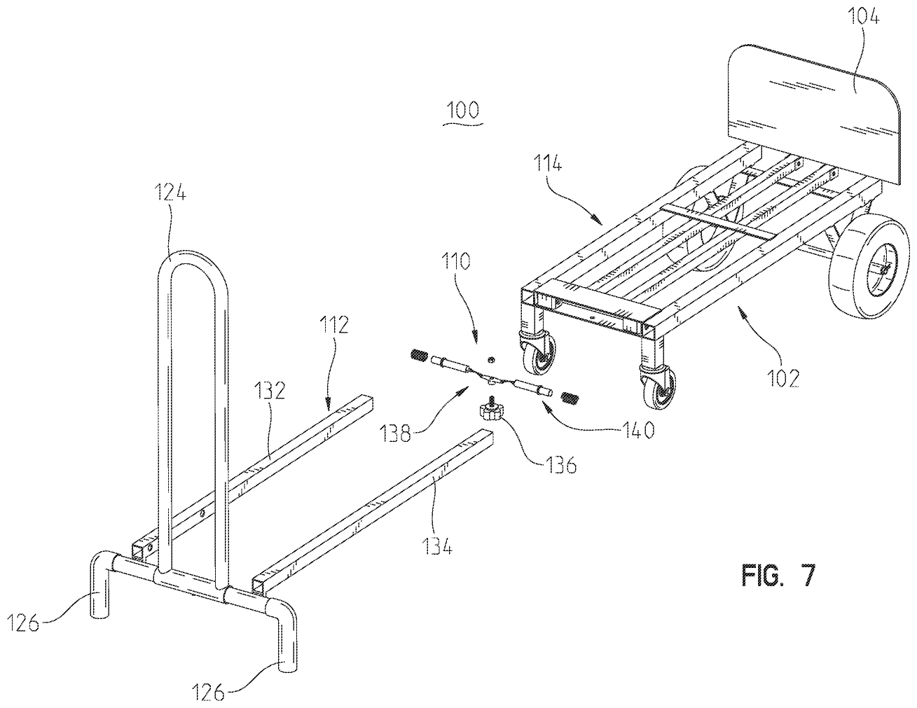

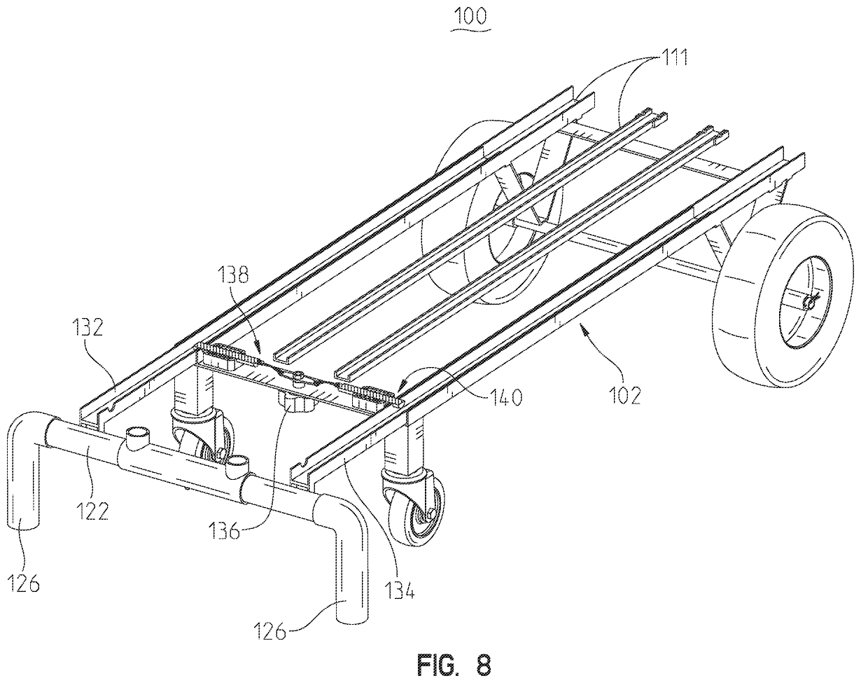

Referring to FIGS. 1-8, an extendable hand truck 100 is shown. Extendable hand truck 100 includes a chassis 102, a nose plate 104, a handle 106, a plurality of wheels 108, and a fastener 110. Chassis 102 includes one or more frame members 111 made of any suitable material (e.g., steel, aluminum, plastic, etc.) secured together using any suitable fastening technique (e.g., welding, bolting, adhesive bonding, etc.). Chassis 102 also includes a first section 112 that is moveable relative to a second section 114. The first section 112 and the second section 114 cooperate to form a cargo support surface 116 on which a cargo or load can be placed.

Nose plate 104 is disposed at a lower end 118 of chassis 102 and attached to chassis 102 in any suitable manner. In one embodiment, nose plate 104 is a planar support plate. In one example, nose plate 104 is foldable.

Handle 106 is disposed at an upper end 120 of chassis 102 and attached to chassis 102 in any suitable manner. Handle 106 includes a connecting member 122, a first handle 124, and second handles 126. In one embodiment, first handle 124 is fitted around connecting member 122 such that first handle 124 is rotatable about a longitudinal axis of connecting member 122. Second handles 126 are fixedly attached to connecting member 122.

Wheels 108 include wheels 108a, 108b (e.g., solid rubber wheels) which are disposed adjacent nose plate 104, and wheels 108c, 108d (e.g., swivel caster wheels) which are disposed adjacent handle 106. Each of wheels 108a-108d is coupled to second section 114 independent of first section 112. Each of wheels 108a-108d extends away from a side of chassis 102 opposite cargo support surface 116. Wheels 108 are adapted to facilitate movement of hand truck 100 relative to a surface (e.g., ground). In a hand truck orientation (where chassis 102 is substantially vertical), wheels 108a, 108b are in contact with the surface to roll over the surface while wheels 108c, 108d are not in contact with the surface. In a cart orientation (where chassis 102 is horizontal), wheels 108a-108d are in contact with the surface to roll over the surface. In one example, hand truck 100 is capable of holding up to 800 lbs. of cargo in both the hand truck orientation and the cart orientation.

For hand truck 100 to be extendable, first section 112 includes one or more extension members 130 mounted in a telescoping relationship with second section 114. As such, one or more extension members 130 allow an operator to adjust a distance between nose plate 104 and handle 106 to thereby vary a length of chassis 102 and modify the surface area of cargo support surface 116. In one embodiment, first section 112 includes a first extension member 132 mounted in a telescoping relationship with second section 114 and a second extension member 134 mounted in a telescoping relationship with second section 114. First and second extension members 132, 134 can extend relative to second section 114 to provide a first area of cargo support surface 116 and retract relative to second section 114 to provide a second area of cargo support surface 116, where the second area is smaller than the first area. In this manner, cargo support surface 116 can be adapted to hold cargos of varying sizes. Accordingly, when compared to conventional hand trucks, extendable hand truck 100 is able to accommodate different sized cargos and transport them safely.

Fastener 110 includes an operator input 136, one or more biasing members 138, and one or more retractable pins 140. Fastener 110 operates to lock or release extension members 132, 134 with respect to second section 114. In a first arrangement of fastener 110, fastener 110 locks first section 112 relative to second section 114. In a second arrangement of fastener 110, fastener 110 permits movement of first section 112 relative to second section 114. In both the first and second arrangements, fastener 110 is carried by one of first section 112 and second section 114.

Operator input 136 is positioned between first and second extension members 132, 134, and on the side of chassis 102 that is opposite cargo support surface 116. In one embodiment, operator input 136 is positioned along a longitudinal centerline plane of hand truck 100. In one example, operator input 136 is a rotatable knob that the operator can manipulate.

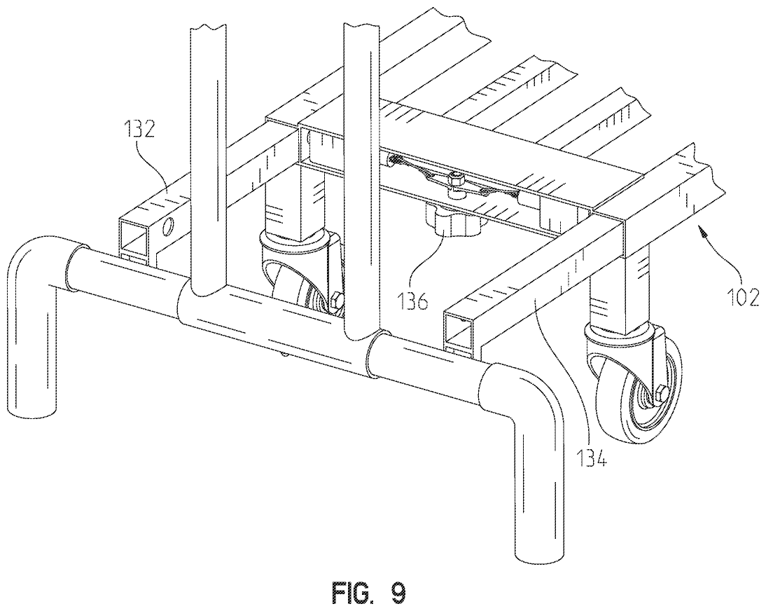

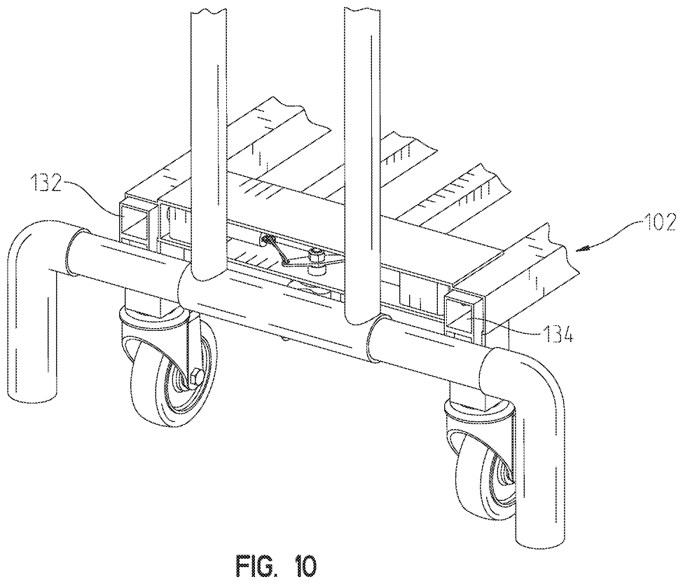

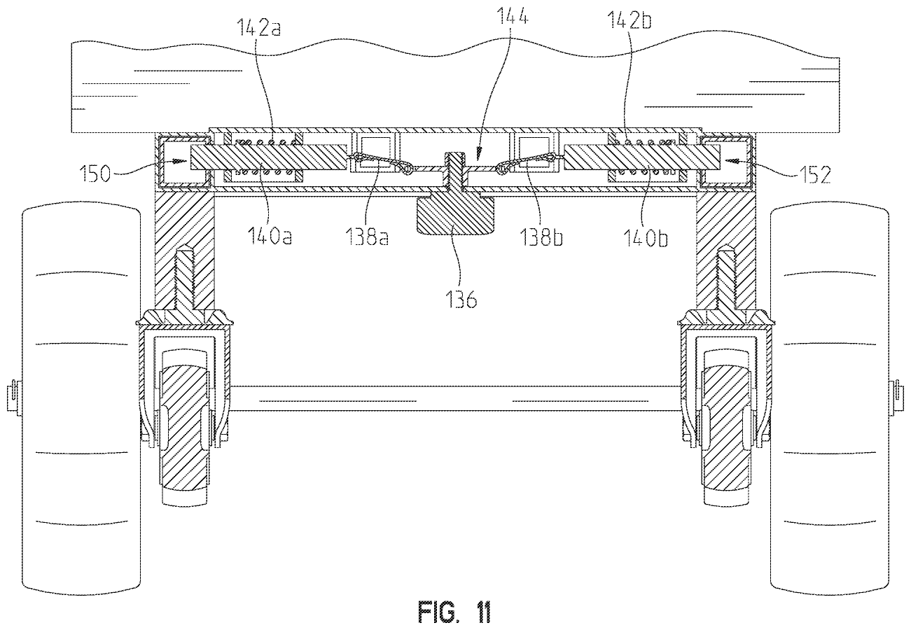

In FIG. 9, first and second extension members 132, 134 are shown to be extended relative to second section 114. In FIG. 10, first and second extension members 132, 134 are shown to be retracted relative to second section 114.

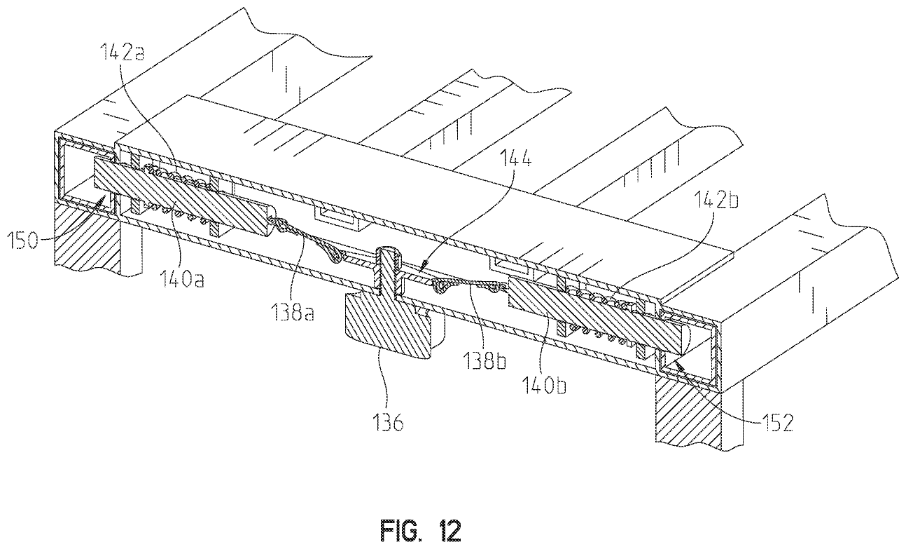

Referring to FIGS. 11 and 12, one or more biasing members 138 include a first biasing member 138a and a second biasing member 138b. Similarly, one or more retractable pins 140 include a first retractable pin 140a and a second retractable pin 140b. Retraction and extension of retractable pins 140a, 140b are supported by respective springs 142a, 142b.

In one embodiment, first and second biasing members 138a, 138b are hooking elements (e.g., S-hooks). As such, hooking elements 138a, 138b are coupled to operator input 136 (via an actuation nut 144) and to respective retractable pins 140a, 140b. In operation, an actuation from operator input 136 moves hooking elements 138a, 138b which in turn move retractable pins 140a, 140b. This enables retractable pins 140a, 140b to be received in or removed from respective openings 150, 152 in extension members 132, 134.

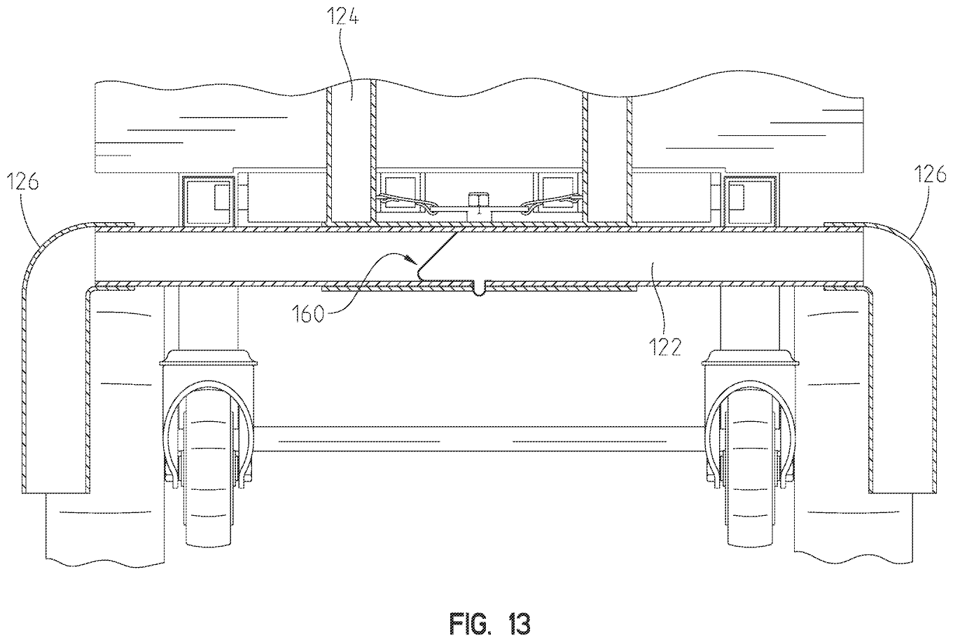

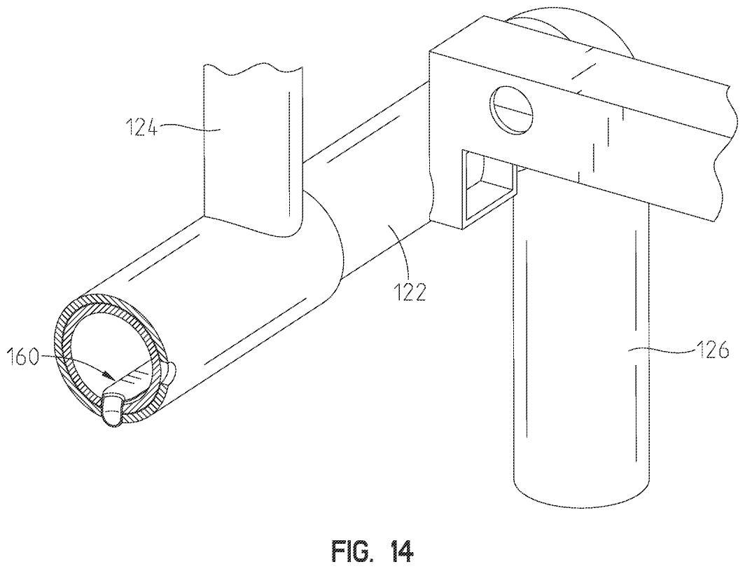

Referring to FIGS. 13 and 14, first handle 124 can be moved between two positions by using a pin 160 (e.g., Valco pin). In a folded position (e.g., when hand truck 100 is in the cart orientation), first handle 124 is aligned parallel to chassis 102. That is, first handle 124 folds down along a backside of first section 112 and second section 114. As such, the operator can move hand truck 100 by pushing on second handles 126. In the cart orientation, nose plate 104 may also serve as a cargo support surface. In an upright position (e.g., when hand truck 100 is in the hand truck orientation), first handle 124 is aligned perpendicular to chassis 102. As such, the operator can move hand truck 100 by pushing or pulling on first handle 124.

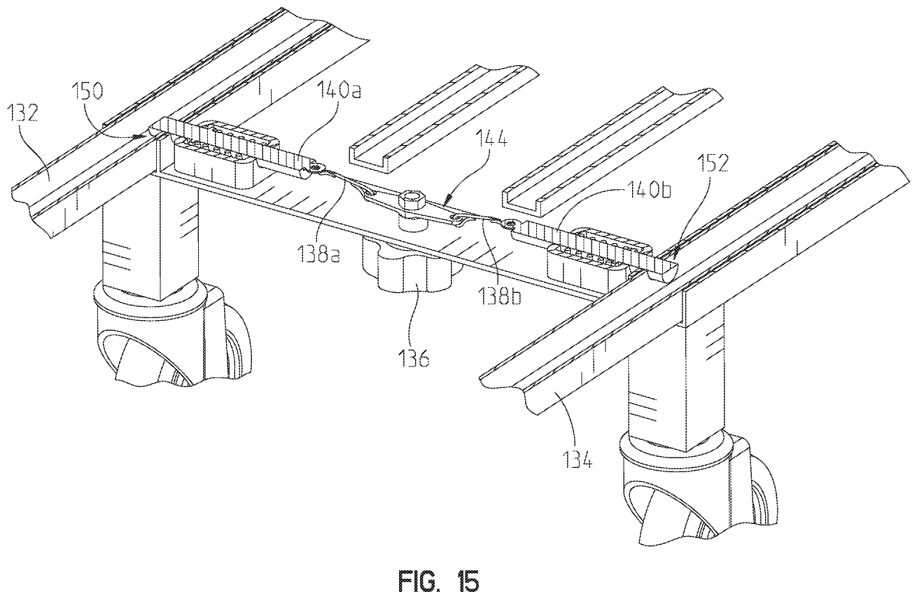

Referring to FIG. 15, the first arrangement of fastener 110 is shown. In the first arrangement, operator input 136 is not actuated. As such, first and second biasing members 138a, 138b bias first and second retractable pins 140a, 140b into respective openings 150, 152. In other words, first retractable pin 140a is received in opening 150 in first extension member 132 and second retractable pin 140b is received in opening 152 in second extension member 134.

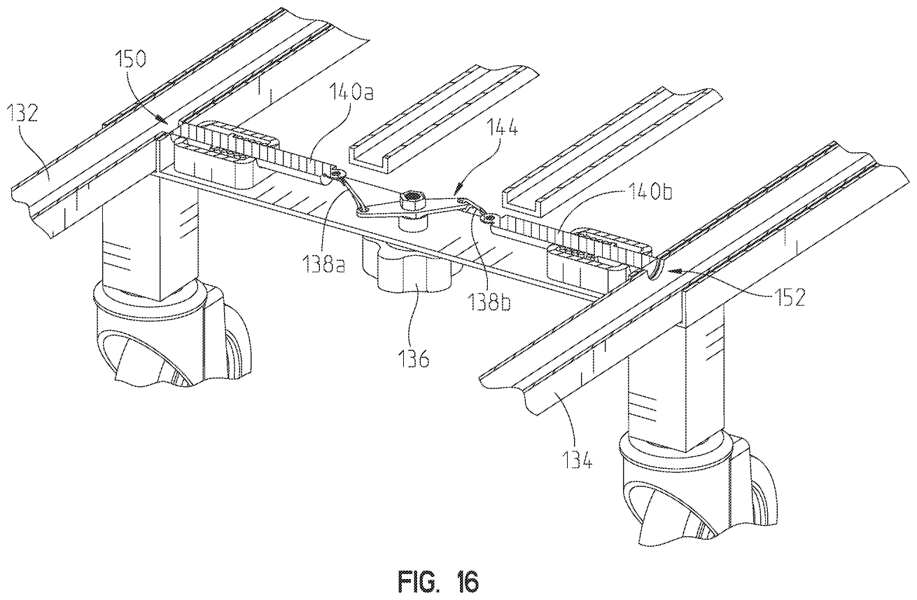

Referring to FIG. 16, the second arrangement of fastener 110 is shown. In the second arrangement, operator input 136 is actuated. For example, the operator rotates operator input 136 in a clockwise direction. This in turn moves actuation nut 144 which pulls on first and second biasing members 138a, 138b. Pulling of first and second biasing members 138a, 138b causes first and second retractable pins 140a, 140b to move out of respective openings 150, 152. In other words, first retractable pin 140a is removed from opening 150 in first extension member 132 and second retractable pin 140b is removed from opening 152 in the second extension member 134.

While this disclosure has been described as having exemplary designs, the present embodiments can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed is:

1. A hand truck comprising:
a chassis having a first section and a second section, the first section being moveable relative to the second section, the first section and the second section cooperating to form a cargo support surface;
a nose plate disposed at a lower end of the chassis;
a handle disposed at an upper end of the chassis;
a plurality of wheels including a first wheel and a second wheel each disposed adjacent the nose plate and a third wheel disposed adjacent the handle; and
a fastener having a first arrangement wherein the fastener locks the first section of the chassis relative to the second section of the chassis and a second arrangement wherein the fastener permits movement of the first section of the chassis relative to the second section of the chassis, the fastener being carried by one of the first section of the chassis and the second section of the chassis in both the first arrangement of the fastener and the second arrangement of the fastener.

2. The hand truck of claim 1, wherein the first section of the chassis includes an extension member mounted in a telescoping relationship with the second section of the chassis, the extension member allowing an operator to adjust a distance between the nose plate and the handle.

3. The hand truck of claim 2, wherein the fastener includes an operator input, a retractable pin and a biasing member;
wherein:
in the first arrangement of the fastener, the retractable pin is received in an opening in the extension member; and
in the second arrangement of the fastener, the retractable pin is removed from the opening in the extension member, the biasing member absent an actuation of the operator input biases the retractable pin into the opening in the extension member.

4. The hand truck of claim 3, wherein the fastener further includes a hooking element coupled to the operator input and the retractable pin;
wherein to move the retractable pin from being received in the opening of the extension member to being removed from the opening in the extension member, the hooking element is moved in response to the actuation of the operator input and in turn moves the retractable pin.

5. The hand truck of claim 1, wherein the first section of the chassis includes a first extension member mounted in a telescoping relationship with the second section of the chassis and a second extension member mounted in a telescoping relationship with the second section of the chassis, the first and second extension members being extended relative to the second section of the chassis to provide a first area of the cargo support surface and retracted relative to the second section of the chassis to provide a second area of the cargo support surface, the second area being smaller than the first area.

6. The hand truck of claim 5, wherein the fastener includes an operator input positioned between the first extension member and the second extension member.

7. The hand truck of claim 6, wherein the operator input is positioned on a first side of the chassis opposite the cargo support surface.

8. The hand truck of claim 7, wherein each of the plurality of wheels extends away from the first side of the chassis opposite the cargo support surface.

9. The hand truck of claim 8, wherein each of the plurality of wheels is coupled to the second section of the chassis independent of the first section of the chassis.

10. The hand truck of claim 6, wherein the fastener includes a pair of retractable pins and a pair of biasing members;
wherein:
in the first arrangement of the fastener, a first retractable pin of the pair of retractable pins is received in an opening in the first extension member and a second retractable pin of the pair of retractable pins is received in an opening in the second extension member; and
in the second arrangement of the fastener, the first retractable pin of the pair of retractable pins is removed from the opening in the first extension member and the second retractable pin of the pair of retractable pins is removed from the opening in the second extension member, the pair biasing members absent an actuation of the operator input biases the pair retractable pins into the respective opening in the first and second extension members.

11. The hand truck of claim 3, wherein the operator input is a rotatable knob.

12. The hand truck of claim 3, wherein the operator input is positioned along a longitudinal centerline plane of the hand truck.

13. The hand truck of claim 1, wherein the hand truck is configured to move between:
a first orientation where the first wheel and the second wheel are in contact with a surface to roll over the surface and the third wheel is not in contact with the surface; and
a second orientation where the first wheel, the second wheel and the third wheel are in contact with the surface to roll over the surface.

14. The hand truck of claim 13, wherein the handle is movable between:
a folded position aligned parallel to the chassis when the hand truck is configured in the first orientation; and
an upright position aligned perpendicular to the chassis when the hand truck is configured in the second orientation.

15. The hand truck of claim 1, wherein the nose plate is movable between:
a folded position wherein the nose plate is parallel to the chassis; and
an upright position wherein the nose plate is perpendicular to the chassis.

16. The hand truck of claim 15, wherein the nose plate in the upright position forms a second cargo support surface.

17. The hand truck of claim 1, wherein the handle comprises a connector for coupling the handle to the upper end of the chassis.

18. The hand truck of claim 17, wherein the handle further comprises a first handle rotatably coupled to the connector.

19. The hand truck of claim 18, wherein the first handle comprises a pin configured to permit the first handle to rotate about the connector.

20. The hand truck of claim 17, wherein the handle further comprises a second handle fixedly coupled to the connector.
